(19) United States
(12) Patent Application Publication
(10) Pub. No.: US 2005/0190659 A1
(43) Pub. Date: Sep. 1, 2005

(54) Audio reproducing apparatus

(75) Inventors: Futoshi Shirakihara, Kyoto (JP); Katsutoshi Ohta, Kyoto (JP); Takeshi Fujita, Osaka (JP); Tomoko Sogabe, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/067,915

(22) Filed: Mar. 1, 2005

(30) Foreign Application Priority Data
Mar. 1, 2004 (JP) 2004-055966

(51) Int. Cl. G11B 7/085

(52) U.S. Cl. 369/30.08

(57) ABSTRACT

To allow high speed search for audio files described in a play list and to quickly perform reproduction of the audio files according to the play list even when a plurality of audio files are recorded on a recording medium, a matching comparison unit for performing a search for a file name described in the play list from file names included in a file name list is provided in a signal processing circuit for performing processing such as decoding of an audio file. When reproduction using the play list is instructed, respective file numbers of the audio files detected in the search by the matching comparison unit are output to a control circuit.

### CROSS REFERENCE TO RELATED APPLICATIONS

This non-provisional application claims priority under 35 U.S.C. § 119(a) on Patent Application No. 2004-055966 filed in Japan on Mar. 1, 2004, the entire contents of which are hereby incorporated by reference.

### BACKGROUND OF THE INVENTION

1. Field of the Invention

The present invention relates to an audio reproducing apparatus for reproducing an audio file.

2. Description of the Prior Art

In recent years, various audio reproducing apparatuses for reproducing audio files recorded on a recording medium such as a CD (compact disc) or CD-ROM (compact-disc read-only memory) have been commercially introduced. Some of those audio reproducing apparatuses have a configuration in which when audio files are reproduced, a file called play list in which the order of the files to be reproduced is described and which is recorded on a recording medium is read out, and the audio files are reproduced according to the order of file names described in the play list (for example, see Japanese Laid-Open Publication No. 2001-202085).

For example, FIG. 1 is a block diagram illustrating the configuration of an audio reproducing apparatus for reproducing audio files according to a description on a play list.

An audio reproducing apparatus 4000 of FIG. 1 includes an external memory 4001, a control circuit 4100 and a signal processing circuit 4200.

In the external memory 4001, a list (file name list) of the file names of audio files recorded on a recording medium 5000 (e.g., CD-ROM) is read and stored. In the file name list, file numbers assigned to the audio files, respectively, are described so as to correspond to the file names, respectively. In the audio reproducing apparatus, as will be described later, the audio files are read out from the recording medium 5000 based on the file numbers and reproduced. Moreover, in the external memory 4001, a play list in which the file names of the audio files are described in the order of the audio files to be reproduced is stored. Furthermore, in the external memory 4001, when the audio files are reproduced, the audio files are read from the recording medium 5000 and then temporarily stored by a recording-medium read-out unit (not shown).

The control circuit 4100 includes an external memory read-out unit 4110, a matching comparison unit 4120, a reproduction order determination unit 4130, and a signal processing circuit interface 4140. The control circuit 4100 performs comparison of a file name described in the play list stored in the external memory 4001 with a file name(s) described in the file name list stored in the external memory 4001 and then instructs a signal processing circuit 4200 to reproduce an audio file with a matching file name. Moreover, the control circuit 4100 also performs other operations such as input operation for an input from a key (not shown), a display operation of a display device for indicating an operation state, and servo control operation. Specifically, the control circuit 4100 includes, for example, a general-purpose microprocessor.

The external memory read-out unit 4110 reads out the play list and the file name list from the external memory 4001.

The matching comparison unit 4120 compares a file name described in the play list read by the external memory read-out unit 4110 with a file name(s) described in a file name list and outputs a file number corresponding to a matching file name to the reproduction order determination unit 4130.

The reproduction order determination unit 4130 determines the order of the audio files to be reproduced based on file numbers received from the matching comparison unit 4120 and outputs a result of the determination to the signal processing circuit interface 4140. Specifically, the reproduction order determination unit 4130 stores, for example, the file numbers in the order in which the file numbers have been received and outputs the file numbers to the signal processing circuit 4200 in the order in which the file numbers have been stored.

The signal processing circuit interface 4140 outputs each of the file numbers to the control circuit interface 4210 according to the reproduction order determined by the reproduction order determination unit 4130.

The signal processing circuit 4200 includes the control circuit interface 4210, an external memory read-out unit 4220, an internal memory 4230 and an audio data decoding unit 4240. The signal processing circuit 4200 reads out an audio file instructed to reproduce by the control circuit 4100 from the external memory 4001 and reproduce the audio file.

The control circuit interface 4210 instructs, based on the file numbers received from the signal processing circuit interface 4140, the external memory read-out unit 4220 to read each of the audio files and the audio decoding processing unit 4240 to decode each of the audio files.

The external memory read-out unit 4220 reads the audio files read by the external memory 4001 and stores the audio files in the internal memory 4230.

The internal memory 4230 stores the audio file output by the external memory read-out unit 4220.

In response to the instruction given by the control circuit interface 4210, the audio data decoding unit 4240 decodes an audio file stored in the internal memory 4230 and outputs the decoded audio file.

In the audio reproducing apparatus 4000 so configured to have the above-described configuration, reproduction of audio files according to a play list in the following manner.

For example, when a user performs a key operation to instruct reproduction according to a play list, the play list and a file name list are first read out from the recording medium 5000 and stored in the external memory 4001.

The matching comparison unit 4120 compares a file name (comparison target character string) in the read out play list with a file name (i.e., a search character string) in the file name list. As a result of the comparison, if the file names do not match each other, the matching comparison unit 4120 reads out another file name from the file name list stored in the external memory 4001 and repeats a comparison operation until a file name from the file name list matches the comparison target character string. The control circuit 4100 needs to perform not only the comparison operation but also other operations such as a key input, a display operation, and a servo control operation. Therefore, if the comparison target character string and the search character string do not match each other, a next comparison operation might have to be waited to be performed.

When the comparison target character string and the search character string match each other, the file number for the matching files is output to the reproduction order determination unit 4130 and the reproduction order determination unit 4130 determines the order of audio files to be reproduced.

When the comparison has been performed to all files in the play list and the order of audio files to be reproduced has been determined, the reproduction order determination unit 4130 outputs the reproduction order to the control circuit interface 4210 via the signal processing circuit interface 4140. The control circuit interface 4210 instructs the external memory read-out unit 4220 to read the audio files and the audio decoding unit 4240 to decode the audio file.

The external memory read-out unit 4220 reads out the audio file from the external memory 4001 and temporarily stores the audio file in the internal memory 4230. When the audio data decoding unit 4240 receives an instruction to decode an audio file from the control circuit interface 4210, the audio data decoding unit 4240 decodes the audio file stored in the internal memory 4230 and outputs decoded data as PCM (pulse code modulation) data.

As described above, in the known audio reproducing apparatus, an audio file can be performed according to description on a play list.

However, the known audio reproducing apparatus has the following problem.

In the known audio reproducing apparatus, a comparison operation of a file name of an audio file described in a play list with a file name(s) of an audio file recorded on the recording medium 5000 is performed by the control circuit. The control circuit, however, needs to perform not only the comparison operation but also a plurality of other operations such as a key input and a servo control operation, and thus, when a comparison target character string and a search character string do not match each other, a next comparison operation might have to be waited to be performed. Specifically, when the comparison operation is continuously performed to a plurality of audio files and some other operation with a higher priority interrupts in the comparison operation, the comparison operation is suspended temporarily until the high priority operation is completed. Therefore, when a plurality of audio files are recorded on the recording medium, the comparison processing takes a long time and reproduction of audio files according to a play list sometimes can not be quickly performed. This problem can be coped with by increasing a processing rate of the control circuit. However, increase in the processing rate of the control circuit raises costs.

### SUMMARY OF THE INVENTION

In view of the problem described above, the present invention has been devised and therefore it is an object of the present invention to provide an audio reproducing apparatus which allows a high-speed search for an audio file described in a play list and quick reproduction of the audio file according to description in the play list even when a plurality of audio files are recorded on a recording medium.

To solve the problem described above, the present invention provides an audio reproducing apparatus for reading one or more audio files recorded on a recording medium according to a play list to indicate a reproduction order and reproducing an audio signal, the apparatus comprising: a signal-processing processor for reproducing the audio signal; and a control processor for controlling an operation of the audio reproducing apparatus. In the audio reproducing apparatus, based on one or more file names included in the play list, the signal-processing processor performs a search in a file list to indicate the one or more audio files recorded on the recording medium for read-out file information to be used for reading each of the one or more audio files from the recording medium, and the control processor controls reproduction of the audio signal in an order according to the play list using the read-out file information detected in the search.

In one embodiment of the present invention, the audio reproducing apparatus further includes an external memory for storing the file list and the play list, the file list includes a file name given to each of the one or more audio files recorded on the recording medium, the control processor outputs an address of the file list stored in the external memory to the signal-processing processor and instructs, using the read-out file information detected in the search, the signal-processing processor to perform reproduction of the audio signal in the order according to the play list, and the signal-processing processor includes an internal memory formed of a memory for temporarily storing the file list and the play list and for performing a data input/output operation at higher speed than an operation speed of the external memory and reproduces the audio signal by reading the file list from the address output by the control processor to the internal memory, comparing the file name described in the read out file list with a file name described in the play list, outputting read-out file information of an audio file having a matching file name and reading the audio file in the order instructed by the control processor in the internal memory.

Thus, when audio files are reproduced according to a play list, the signal processing circuit performs a search for an audio file instructed to be reproduced in a file list. Therefore, time required for the comparison is less influenced by a state of a load of the control circuit. Accordingly, reproduction of the audio files can be quickly started. Moreover, the audio reproducing apparatus is so configured to perform a search (comparison of character strings) by the signal-processing processor. Thus, comparison between file names can be performed at higher speed, for example, compared to the case where some other general-purpose microprocessor is provided for comparison of character stings, without increasing costs.

According to one embodiment of the present invention, in the audio reproducing apparatus, the file list includes a file name given to each of the one or more audio files recorded on the recording medium, when a character code system of the file name included in the file list is different from a character code system of a file name included in the play list, the control processor instructs the signal-processing processor to convert at least one of the character code system of the file name included in the file list and the character code system of the file name included in the play list into a predetermined character code system so that the character code systems of the file name included in the file list and the file name included in the play list become the same, and the signal-processing processor performs the search according to an instruction by the control processor after the conversion for the character code systems has been performed.

Thus, even when the respective character code systems of a play list and file name list are different from one another, comparison between file names can be performed.

According to one embodiment of the present invention, in the audio reproducing apparatus, the control processor outputs information indicating the size of the file list to the signal-processing processor, and the signal-processing processor further includes an internal memory for temporarily storing the file list, reads the file list by performing read operations of a plurality of times, and performs the search at each time when a read operation is performed.

Thus, the file name list is read by reading operations of a plurality of times according to the capacity of the internal memory. Therefore, even when many audio files are stored in the recording medium or the character string of a file name has a great length and thus the size of the file name list is increased, comparison between file names can be performed at high speed.

According to one embodiment of the present invention, in the audio reproducing apparatus, the signal-processing processor has a first reading function of reading a certain number of characters of a file name described in the file list to the internal memory, regardless of a length of the file name, and a second reading function of reading all characters of the file name into the internal memory, and the control processor instructs the signal-processing processor which of the first reading function or the second reading function is used to read the file name.

Thus, a first comparison function of performing comparison using only a certain number of characters of each file name, regardless of the length of a file name described in the file name list, and a second comparison function of performing comparison using all characters of each file name can be appropriately used. Specifically, when comparison between file names is performed using only a certain number of characters of each file name, high speed comparison can be performed, a search can be performed to many files and an audio file having a file name of which a certain number of characters match with those of a target file name is reproduced. Moreover, when comparison between file names is performed using all characters of each file name, a search can be precisely performed.

According to one embodiment of the present invention, in the audio recording apparatus, when performing the search to part of the file list, the control processor instructs the signal-processing processor in what range of the file list the signal-processing processor performs the search, and the signal-processing processor performs the search to the range of the file list.

Thus, a search can be performed with a narrowed search range, so that time required for a search can be reduced.

According to one embodiment of the present invention, the audio reproducing apparatus further includes: an external memory to which the file list is read, the one or more audio files recorded on the recording medium is stored in a hierarchical structure, the file list includes a directory name to identify a directory in a hierarchy, in the play list, the directory name is described so as to correspond to the file name, when the file list is read to the external memory, the control processor outputs a first address in which information for the file name included in the file list is stored and a second address in which information for the directory name included in the file list to the signal-processing processor, and the signal-processing processor performs a search for the file reading information, based on the file name included in the play list, from the information for the file name read out from the first address, and a search for information to specify a directory for reading each of the audio files from the recording medium from the information for the directory name read out from the second address.

Thus, even when a target for a search is a directory, the same search method can be applied only by changing a location in the external memory to which a reading operation is performed.

According to one embodiment of the present invention, in the audio reproducing apparatus, the recording medium allows storage of audio files having a same file name, when an audio file corresponding to the read-out file information detected in the search by the signal-processing processor is not included in the directory to which the search is performed, the control processor instructs a re-search in the file list, and when the re-search is instructed, the signal-processing processor performs a search to part of the file list which has not been subjected to a search.

Thus, for example, even when audio files with the same file name exist in a file name list, an audio file to be reproduced can be precisely found by a search.

### BRIEF DESCRIPTION OF THE DRAWINGS

FIG. 1 is a block diagram illustrating the configuration of a known audio reproducing apparatus.

FIG. 2 is a block diagram illustrating the configuration of an audio reproducing apparatus according to Embodiment 1 of the present invention.

FIG. 3 is a block diagram illustrating the configurations of a control circuit and a control circuit interface in the audio reproducing apparatus of Embodiment 1 of the present invention.

FIG. 4 is a flow chart showing a reproduction operation of the audio reproduction apparatus of Embodiment 1 of the present invention according to a play list.

FIG. 5 is a block diagram illustrating an audio reproducing apparatus according to Embodiment 2 of the present invention.

FIG. 6 is a block diagram illustrating the configurations of a control circuit and a control circuit interface in the audio reproducing apparatus of Embodiment 2 of the present invention.

### DESCRIPTION OF THE PREFERRED EMBODIMENTS

Hereinafter, embodiments of the present invention will be described with reference to the accompanying drawings.

### Embodiment 1

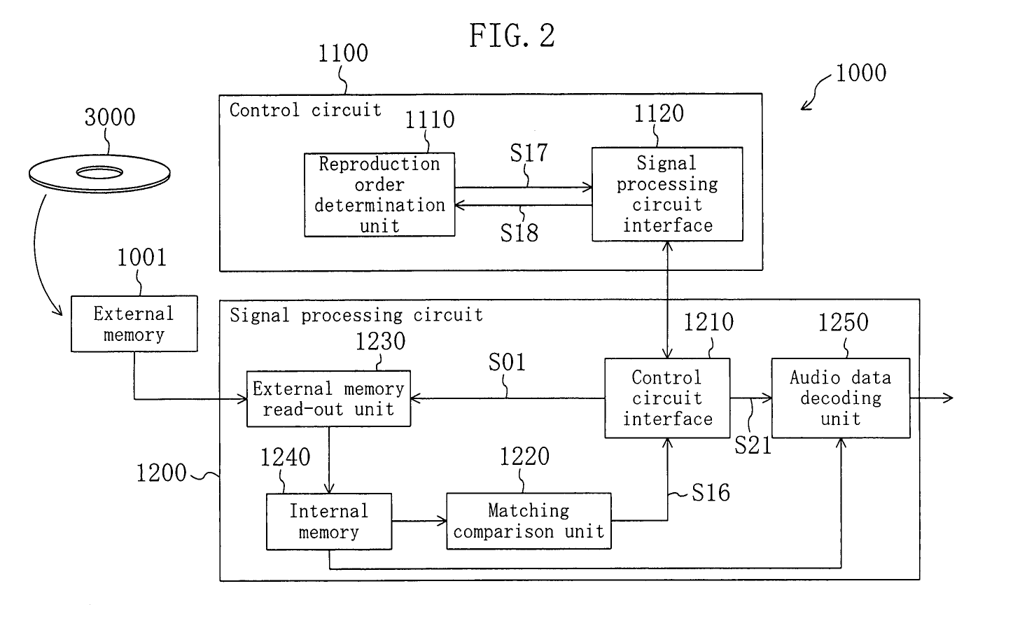

FIG. 2 is a block diagram illustrating the configuration of an audio reproducing apparatus 1000 according to Embodiment 1 of the present invention.

As shown in FIG. 2, the audio reproducing apparatus 1000 includes an external memory 1001, a control circuit 1100 and a signal processing circuit 1200. The audio reproducing apparatus 1000 reproduces audio files recorded on a recording medium 3000 (e.g., CD-ROM) according to a play list in which the file names of audio files are described in the order in which the audio files are reproduced.

The external memory 1001 stores a list (file name list) of the file names of audio files recorded on the recording medium 3000. In the file name list, file numbers assigned to the audio files, respectively, are described so as to correspond to the file names, respectively. In the audio reproducing apparatus of this embodiment, as will be described later, audio files are read out from the recording medium 3000 based on the file numbers and then reproduced.

Moreover, the external memory 1001 reads out the play list from the recording medium 3000 and stores the read out play list. In the audio reproducing apparatus of this embodiment, the play list is stored at a fixed address in the external memory 1001.

Moreover, in the external memory 1001, audio files are stored by an audio-file recording-medium read-out unit (not shown).

The control circuit 1100 includes a reproduction order determination unit 1110 and a signal processing circuit interface 1120. The control circuit 1100 determines the order of audio files to be reproduced and instructs the signal processing circuit 1200 to reproduce audio files according to the determined order. Moreover, the control circuit 1100 also performs other operations such as an input operation from a key (not shown), a display operation of a display device and a servo control operation. The control circuit 1100 includes, for example, a general-purpose microprocessor.

The reproduction order determination unit 1110 receives a file number S18 (i.e., a signal to indicate a file number) from the signal processing circuit interface 1120 to determine the order of audio files to be reproduced and outputs a decode instruction S17 (i.e., a signal to indicate a start of decoding) to the signal processing circuit 1200 via the signal processing circuit interface 1120. Specifically, for example, the reproduction order determination unit 1110 stores file numbers in the order in which the file numbers have been received from the signal processing circuit interface 1120 and outputs the received file numbers to the signal processing circuit 1200 in the order in which the file numbers have been stored.

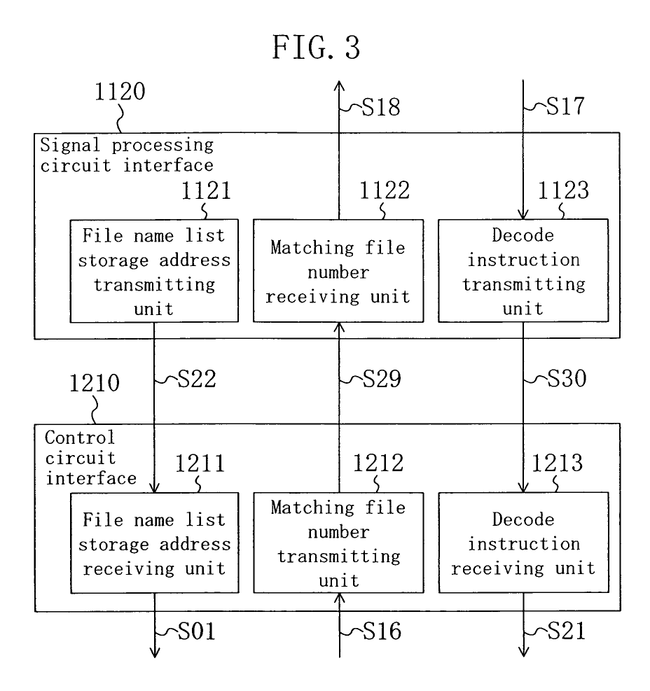

As shown in FIG. 3, the signal processing circuit interface 1120 includes a file name list storage address transmitting unit 1121, a matching file number receiving unit 1122 and a decode instruction transmitting unit 1123.

The file name list storage address transmitting unit 1121 outputs address information S22 (i.e., a signal to indicate an address in which a file name list is recorded) to the file name list storage address receiving unit 1211 (which will be described later). Specifically, if the control circuit 1100 stores the address when the file name list is read, an address in which a file name list is recorded can be output.

The matching file number receiving unit 1122 outputs a file number S29 (i.e., a signal to indicate a file number) received from a matching file number transmitting unit 1212 (which will be described later) to the file number S18 to the reproduction order determination unit 1110.

The decode instruction transmitting unit 1123 outputs the decode instruction S17 received from the reproduction order determination unit 1110 to a decode instruction S30 to a decode instruction receiving unit 1213 (which will be described later).

The signal processing circuit 1200 includes a control circuit interface 1210, a matching comparison unit 1220, an external memory read-out unit 1230, and an internal memory 1240 and an audio data decoding unit 1250. The signal processing circuit 1200 performs comparison (i.e., a search for a matching file name) between a file name of an audio file described on a play list and a file name (i.e., a search character string) of an audio file described on a file name list and reproduces audio files in the order instructed by the control circuit 1100. Specifically, the signal processing circuit 1200 includes a DSP (digital signal processor) designed for performing a high-speed digital operation to a signal. The DSP is capable of repeating digital signal processing and performing a data input/output at very high speed, compared to the general-purpose microprocessor.

As shown in FIG. 3, the control circuit interface 1210 includes the file name list storage address receiving unit 1211, the matching file number transmitting unit 1212 and the decode instruction receiving unit 1213.

The file name list storage address receiving unit 1211 receives the address information S22 from the file name list storage address transmitting unit 1121 and outputs address information S01 to the control circuit interface 1210.

The matching file number transmitting unit 1212 receives a file number S16 (which will be described later) from the matching comparison unit 1220 and outputs the file number S29 to the matching file number receiving unit 1122.

The decode instruction receiving unit 1213 receives the decode instruction S30 from the decode instruction transmitting unit 1123 and outputs a decode instruction S21 to the audio data decoding unit 1250.

The matching comparison unit 1220 compares a file name described in a play list stored in the internal memory 1240 with a file name described in the file name list, obtains a file number corresponding to a matching file name from the file name list and outputs the obtained file number to the matching file number transmitting unit 1212.

The memory read-out unit 1230 reads out a file name list from an address in the internal memory 1001 indicated by the address information S01, a play list and an audio file corresponding to a file number and stores the read out file name file and the like in the internal memory 1240.

The internal memory 1240 is formed of a memory capable of performing an input/output operation at higher speed than the external memory 1001. The internal memory 1240 stores the file name list and the like read by the external memory read-out unit 1230. With the internal memory 1240 formed of a memory capable of performing an input/output operation at higher speed than the external memory 1001, comparison of file names by the matching comparison unit 1220 and the like can be performed at higher speed.

When the audio data decoding unit 1250 receives the decode instruction S21 from the decode instruction receiving unit 1213, the audio data decoding unit 1250 decodes a signal recorded in an audio file stored in the internal memory 1240 on real time (i.e., performs a real-time reproduction operation) and outputs the signal as PCM (pulse code modulation) data.

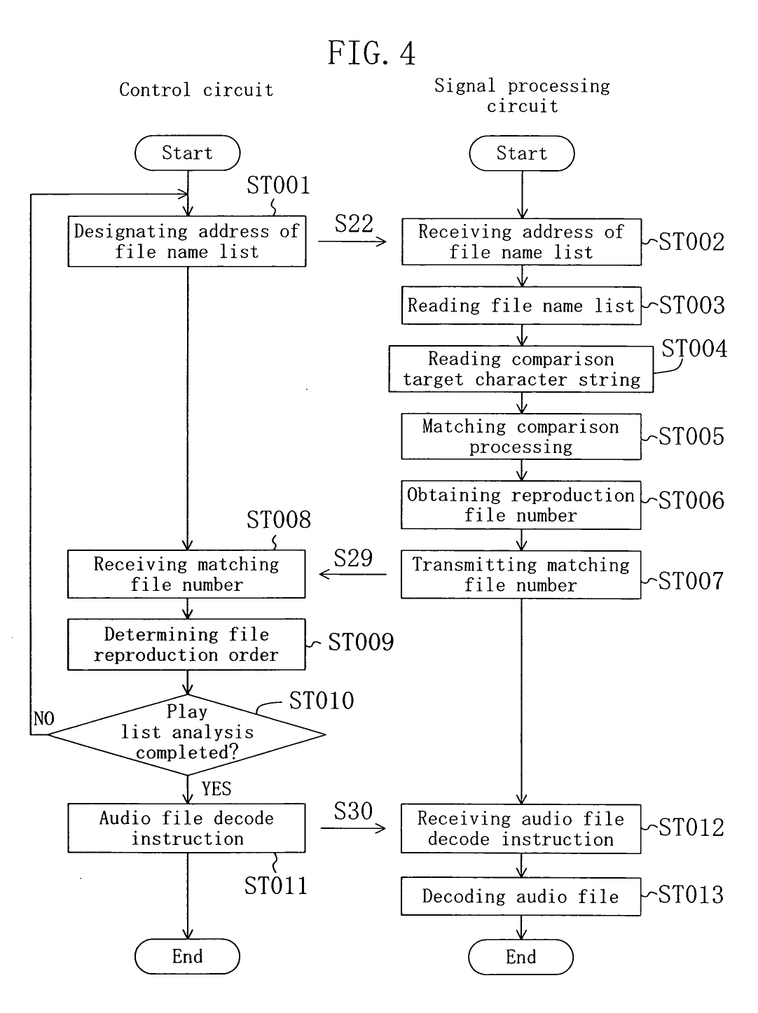

In the audio reproducing apparatus 1000 having the above-described configuration, when a user instructs reproduction based on a play list, the play list and a file name list are read from the recording medium 3000 to the external memory 1001 and, furthermore, a processing shown in a flow chart of FIG. 4 is performed, thereby reproducing audio files recorded in the recording medium 3000 according to the play list.

[ST001] The file name list storage address transmitting unit 1121 outputs address information S22 to the file name list storage address receiving unit 1211.

[ST002] The file name list storage address receiving unit 1211 outputs the received address information S22 as address information S01 to the external memory read-out unit 1230.

[ST003] The external memory read-out unit 1230 reads a file name list from an address in the external memory 1001 indicated by the address information S01 and stores the read-out file name list in the internal memory 1240.

[ST004] The external memory read-out unit 1230 reads a play list in the external memory 1001 and stores the read-out play list in the internal memory 1240.

Through the above-described processing from ST001 to ST004, the play list and the file name list are stored in the internal memory 1240.

[ST005] The matching comparison unit 1220 compares a file name (comparison target character string) in the play list with all of file names in a file name list stored in the internal memory 1240.

If a matching file name is found, the process proceeds with ST006, and if no matching file is found, the process proceeds with ST010.

[ST006] The matching comparison unit 1220 obtains a file number corresponding to a matching file name from the file name list.

[ST007] The matching comparison unit 1220 outputs the obtained file number as a file number S16 to the matching file number transmitting unit 1212 and the matching file number transmitting unit 1212 outputs the file number S16 as a file number S29 to the matching file number receiving unit 1122.

[ST008] The matching file number receiving unit 1122 outputs the received file number S29 as a file number S18 to the reproduction order determination unit 1110.

[ST009] The reproduction order determination unit 1110 stores the file number S18 received from the matching file number receiving unit 1122 in the order in which the file number S18 has been received.

[ST010] It is confirmed whether or not the processing from ST001 to ST009 is completed for all of the file names described in the play list. If the processing is not completed, the processing proceeds with ST001, and if the processing is completed, the process proceeds with ST011.

[ST011] When the processing from ST001 to ST009 for all of the file names described in the play list is completed, a final order of audio files to be reproduced is determined.

When the final order of audio files to be reproduced has been determined, the reproduction order determination unit 1110 outputs the decode instruction S17 for each audio file to the decode instruction transmitting unit 1123. The decode instruction transmitting unit 1123 outputs the received decode instruction S17 as a decode instruction S30 to the decode instruction receiving unit 1213.

[ST012] The decode instruction receiving unit 1213 receives the decode instruction S30 from the decode instruction transmitting unit 1123 and outputs a decode instruction S21 to the audio data decoding unit 1250. Moreover, the control circuit 1100 instructs the audio-file recording-medium read-out unit to read an audio file to be reproduced, so that the audio file is stored in the external memory 1001.

When the control circuit interface 1210 instructs the audio-file recoding-medium read-out unit to read the audio file, the external memory read-out unit 1230 reads the audio file from the external memory 1001 and stores the audio file in the internal memory 1240.

[ST013] The audio data decoding unit 1250 reads the audio file stored in the internal memory 1240, performs decoding thereto and outputs PCM data.

As has been described, according to this embodiment, when audio files are reproduced according to a play list, a signal processing circuit compares a file name described on a play list with a file name(s) described in a file name list. Thus, time required for the comparison is less influenced by a state of a load in a control circuit, so that reproduction can be quickly started.

Moreover, the audio reproducing apparatus of this embodiment is so configured that comparison of character strings is performed by a signal processing circuit formed of a DSP capable of repetition of digital signal processing and data transfer to a memory at very high speed, compared to a general-purpose microprocessor. Thus, for example, compared to the case where some other general-purpose microprocessor is provided for performing the comparison, file names can be compared at higher speed without increasing costs.

### Embodiment 2

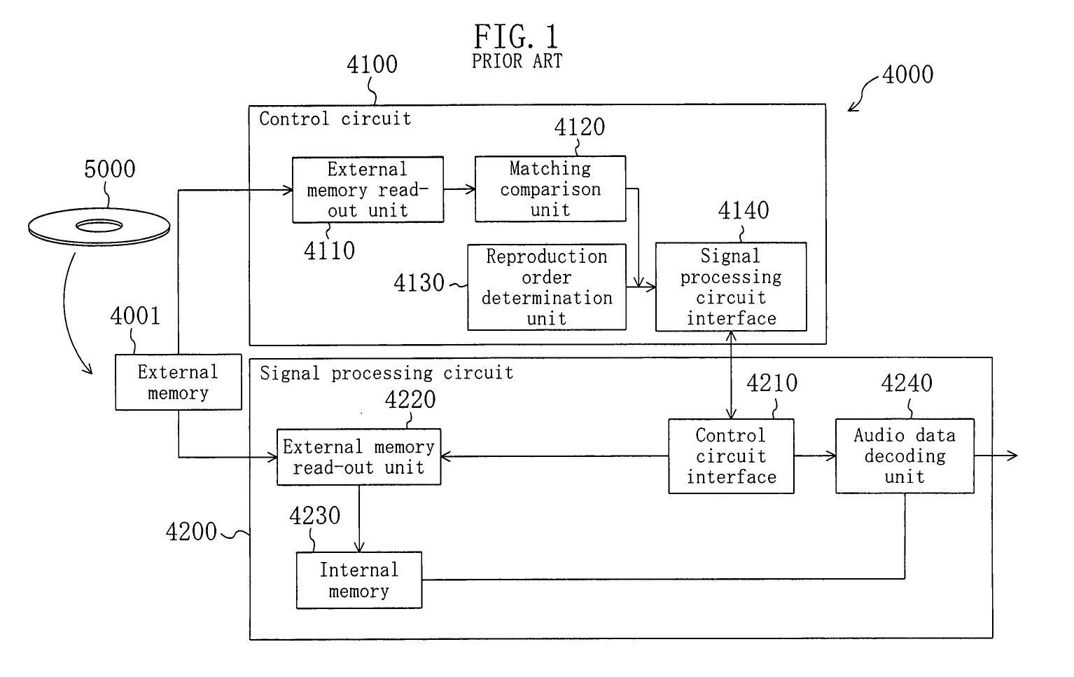

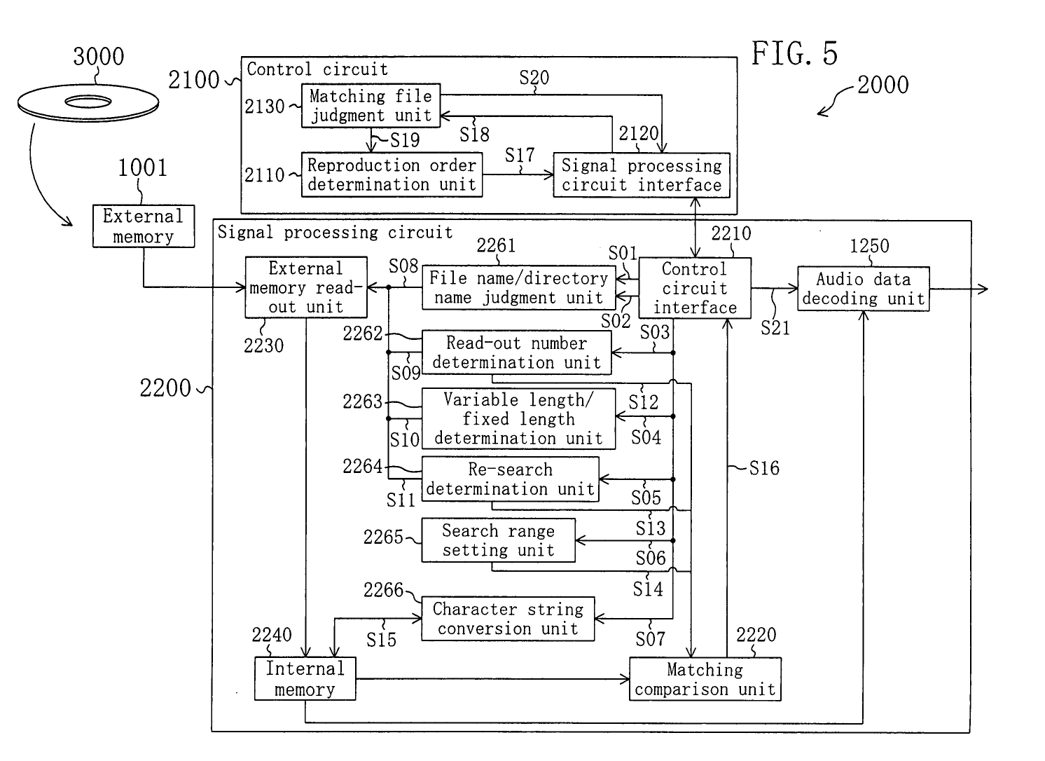

FIG. 5 is a block diagram illustrating the configuration of an audio reproducing apparatus 2000 and a recording medium 3000 according to Embodiment 2 of the present invention. In FIG. 5, each member also shown in FIG. 1 is identified by the same reference numeral and therefore the description thereof will be omitted.

An exemplary file system of the recording medium 3000 described in this embodiment has a hierarchical structure. Thus, in a play list, each audio file is specified by a directory name and a file name, and audio files are described in the order to be reproduced. Also, directory names as well as file names are described in a file name list.

Moreover, as in the file name list in Embodiment 1, file numbers assigned to the audio files, respectively, are described so as to correspond to the file names, respectively. The audio files are read out from the recording medium 3000 based on file numbers and then reproduced.

As shown in FIG. 5, an audio reproducing apparatus 2000 includes an external memory 1001, a control circuit 2100 and a signal processing circuit 2200.

In the external memory 1001, a list of file names (file name list) of audio files recorded in the recording medium 3000 is stored and also the play list is read from the recording medium 3000 and stored. In the audio reproducing apparatus of this embodiment, a play list is stored at a fixed address in the external memory 1001.

Moreover, in the external memory 1001, audio files are stored by an audio-file recording-medium read-out unit (not shown).

The control circuit 2100 includes a reproduction order determination unit 2110, a signal processing circuit interface 2120 and a matching file judgment unit 2130.

Moreover, the control circuit 2100 also performs other operations such as an input operation from a key (not shown), a display operation of a display device, and a servo control operation. Specifically, the control circuit 2100 includes, for example, a general-purpose microprocessor.

The reproducing order determination unit 2110 determines the order of the audio files to be reproduced based on a file number S19 (a signal to indicate a file number) received from the matching file judgment unit 2130 and outputs a decode instruction S17 to the signal processing circuit 2200 via the signal processing circuit interface 2120. Specifically, for example, the reproduction order determination unit 2110 stores file numbers according to the order in which the file numbers have been received from the control circuit interface 2210 and outputs the file numbers to the signal processing circuit 2200 in the order in which the file numbers have been stored.

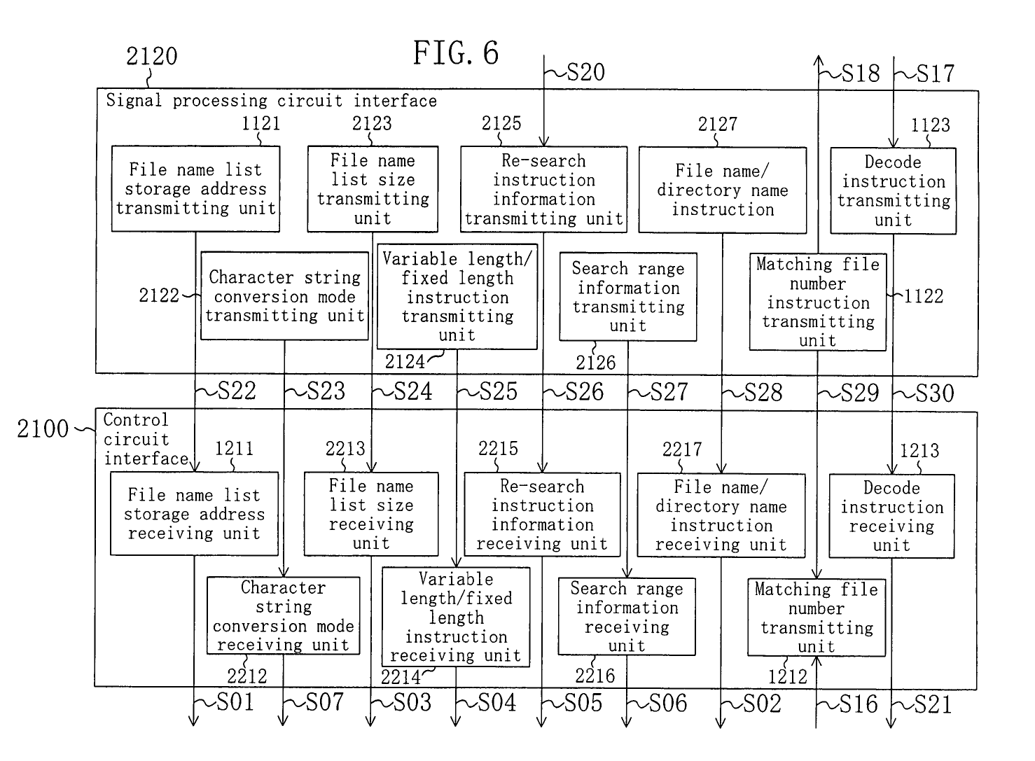

As shown in FIG. 6, the signal processing circuit interface 2120 includes the same members as those of the signal processing circuit interface 1120 of Embodiment 1 and further includes a character string conversion mode transmitting unit 2122, a file name list size transmitting unit 2123, a variable length/fixed length instruction transmitting unit 2124, a re-search instruction information transmitting unit 2125, a search range information transmitting unit 2126 and a file name/directory name instruction transmitting unit 2127.

In this embodiment, address information S22 output by a file name list storage address transmitting unit 1121 is a signal to indicate an address in the external memory 1001 in which directory names described in the file name list are stored as well as an address in the external memory in which file names described in the file name list are stored.

The character string conversion mode transmitting unit 2122 outputs, to a character string conversion mode receiving unit 2212, character string conversion mode information S23 to indicate in what character code system a comparison target character string is described.

The file name list size transmitting unit 2123 outputs size information S24 (i.e., a signal to indicate the size of a file name list) to the file name list size receiving unit 2213. Specifically, the size of a file name list is calculated by the control circuit 2100 based on the number of audio files obtained by accessing the recording medium 3000 by the control circuit 2100 and the number of characters in each of the audio file names. For example, the length of a file name is a fixed length, the size of a file name list can be obtained by multiplying the number of files by the length of a file name.

The variable length/fixed length instruction transmitting unit 2124 outputs variable length/fixed length instruction information S25 to the variable length/fixed length instruction transmitting unit 2214. The variable length/fixed length instruction information S25 is a signal to instruct the external memory read-out unit 2230 to read a fix length of each file name, regardless of the length of a file name stored in the external memory 1001, or read a whole character string of each file name according to the length of character string of each file name, when the external memory read-out unit 2230 reads out file names stored in the file name list from the external memory 1001. Which the number of characters of a file name is obtained based on a variable length which varies according to the length of a character string of a file name or a fixed length may be fixedly determined in advance for the audio reproducing apparatus or may be defined by a user.

The re-search instruction information transmitting unit 2125 receives a re-search instruction signal S20 (which will be described later) from the matching file judgment unit 2130 and outputs a re-search instruction signal S26 to the re-search instruction information receiving unit 2215.

The search range information transmitting unit 2126 outputs search range information S27 to the search range information receiving unit 2216. The search range information S27 is a signal to indicate what range in the read file name list a search is performed to. For example, a search range may be fixed in advance so that a search is always performed to only a certain number of initial file names in a file name list or may be defined by a user.

The file name/directory name instruction transmitting unit 2127 outputs file name/directory name instruction information S28 to the file name/directory name instruction receiving unit 2217. The file name/directory name instruction information S28 is a signal to indicate which a search is performed using a directory name or a file name described in a file name list.

When the received file number S18 is the file number of an audio file included in a directory to which a search is performed, the matching file judgment unit 2130 outputs the file number S18 as a file number S19 to the reproduction order determination unit 2110. When the received file number S18 is not the file number of an audio file included in a directory to which a search is performed, the matching file judgment unit 2130 outputs the re-search instruction signal S20 to the re-search instruction information transmitting unit 2125. The re-search instruction signal S20 is a signal to instruct the matching comparison unit 2220 to compare the play list and a file name list again.

The signal processing circuit 2200 includes an external memory read-out unit 2230, an audio data decoding unit 1250, a control circuit interface 2210, a matching comparison unit 2220, an internal memory 2240, a file name/directory name judgment unit 2261, a read-out number determination unit 2262, a variable length/fixed length determination unit 2263, a re-search judgment unit 2264, a search range setting unit 2265 and a character string conversion unit 2266. The signal processing circuit 2200 compares a file name of an audio file described in a play list with a file name(s) of an audio file(s) described in a file name list, reads audio files from the external memory 1001 in the order instructed by the control circuit 2100, and then reproduces the audio files. Specifically, as the signal processing unit 1200 of Embodiment 1, the signal processing circuit 2200 includes a DSP or the like.

As shown in FIG. 6, the control circuit interface 2210 includes the same members as those of the control circuit interface 1210 of Embodiment 1 and further includes a character string conversion mode receiving unit 2212, a file name list size receiving unit 2213, a variable length/fixed length instruction receiving unit 2214, a re-search instruction information receiving unit 2215, a search range information receiving unit 2216 and a file name/directory name instruction receiving unit 2217.

The character string conversion receiving unit 2212 outputs received character string conversion mode information S23 as character string conversion mode information S07 to the character string conversion unit 2266.

The file name list size receiving unit 2213 outputs received size information S24 as size information S03 to the read-out number determination unit 2262.

The variable length/fixed length instruction receiving unit 2214 outputs received variable length/fixed length instruction information S25 as variable length/fixed length instruction information S04 to the variable length/fixed length determination unit 2263.

The search instruction information receiving unit 2215 outputs a received re-search instruction signal S26 as a re-search instruction signal S05 to the re-search determination unit 2264.

The search range information receiving unit 2216 outputs received range information S27 as search range information S06 to the search range setting unit 2265.

The file name/directory name instruction receiving unit 2217 outputs received file name/directory name instruction information S28 as file name/directory name instruction information S02 to the file name/directory name determination unit 2261.

The matching comparison unit 2220 performs comparison between a file name described in a play list stored in the internal memory 2240 with a file name described in a file name list for the number of times determined by the read-out number determination unit 2262 to find if the file names match each other. If a matching name is found, the file number thereof is output to the matching file number transmitting unit 1212. If no matching file name is found, an error number is output to the matching file number transmitting unit 1212.

Moreover, when the matching comparison unit 2220 receives a re-search instruction signal S13 (which will be described later), the matching comparison unit 2220 compares the file name to which the previous comparison has been performed with a subsequent file name in the file name list without changing the comparison target character string.

The external read-out unit 2230 reads a play list and audio files from the external memory 1001 and outputs the play list and the audio files to the internal memory 2240.

Moreover, the external memory read-out unit 2230 reads a file name included in the file name list from the external memory 1001 and outputs the file name to the internal memory 2240 by one of two methods, i.e., a method for reading a fixed length of each file name, regardless of the length of each file name, and a method for reading a file name according to the character string length of each file name.

The internal memory 2240 is formed of, for example, a memory capable of performing an input/output operation at higher speed than the external memory 1001 and stores the file name list and the like read by the external memory read-out unit 2230. With the internal memory 2240 formed of a memory capable of performing an input/output operation at higher speed than the external memory 1001, comparison of file names by the matching comparison unit 2220 can be performed at even higher speed.

The file name/directory name determination unit 2261 obtains, from address information S01 and the file name/directory instruction information S02, an address used for reading a file name list by the external memory read-out unit 2230 and outputs the address. Specifically, for example, if the file name/directory name instruction information S02 indicates a search for a directory name, an address of a directory name indicated by the address information S01 is output, and if the file name/directory name instruction information S02 indicates a search for a file name, an address of a file name indicated by the address information S01 is output.

The read-out number determination unit 2262 obtains how many times a read operation is performed to read a file name list according to the capacity of the internal memory 2240 and outputs read number S09 (i.e., a signal to indicate the obtained number) to the external memory read-out unit 2230. Specifically, the read number is calculated, for example, by dividing the size of the file name list by the capacity of the internal memory 2240 used for storing the file name list.

The variable length/fixed length determination unit 2263 instructs, based on variable length/fixed length instruction information S04, the external memory read-out unit 2230 which read-out method is used to read out a file name included in the file name list (by a signal S10). Specifically, as a read-out method, one of two methods, i.e., a method for reading a fixed length of each file name, regardless of the length of the file name, and a method for reading a file name according to the character string length of each file name is set.

If the re-search determination unit 2264 receives a re-search instruction signal S05 from the re-search instruction information receiving unit 2215 and the comparison is not completed to all of files in the file name list, the re-search determination unit 2264 outputs a re-search instruction signal S13 (i.e., a signal to instruct execution of a re-search) to the matching comparison unit 2220.

The search range setting unit 2265 sets a search range of a file name list for the external memory read-out unit 2230 and outputs a search range signal S14 (i.e., a signal to indicate a search range) to the matching comparison unit 2220. For example, if the search range information S06 indicates a search for only a certain number of initial files in the file name list, the file number of each of the files is output as a search range signal S14 to the matching comparison unit 2220.

The character string conversion unit 2266 converts, based on character string conversion mode information S07, a file name described in the play list stored in the internal memory 2240 into the same character code system as that of a file name described in the file name list.

In the audio reproducing apparatus 2000 so configured to have the above-described structure, audio files are reproduced according to a play list in the following manner.

For example, when reproduction of audio files according to a play list is instructed by a key operation by a user and the like, in the external memory 1001, a file name list and a play list are first read from the recording medium 3000 and stored.

Then, address information S22 is output from the file name list storage address transmitting unit 1121 of the control circuit 2100 and character string conversion mode information S23 is output from the character string conversion mode transmitting unit 2122, address information S24 is output from the file name list size transmitting unit 2123, variable length/fixed length instruction information S25 is output from the variable length/fixed length instruction transmitting unit 2124, search range information S27 is output from the search range information transmitting unit 2126 and a file name/directory name instruction information S28 is output from the file name/directory name instruction transmitting unit 2127.

When the size information S24 is output to the file name list size receiving unit 2213, the file name list size receiving unit 2213 outputs size information S03 to the read-out number determination unit 2262. The read-out number determination unit 2262 calculates, based on the file name list size information S03, the number of read operations to read a file name list and then outputs the number of read operations.

Moreover, when the address information S22 is output to the file name list storage address receiving unit 1211, the file name list storage address receiving unit 1211 outputs address information S01 to the file name/directory name determination unit 2261.

Moreover, when the file name/directory name instruction information S28 is output from the file name/directory name instruction transmitting unit 2127 to the file name/directory name instruction receiving unit 2217, the file name/directory name instruction receiving unit 2217 outputs file name/directory name instruction information S02 to the file name/directory name determination unit 2261.

When the file name/directory name determination unit 2261 receives the address information S01 and the file name/directory name instruction information S02, the file name/directory name determination unit 2261 obtains an address in the external memory 1001 in which a file name list to be a target for a search and outputs the address to the external memory read-out unit 2230.

When the variable length/fixed length instruction information S25 is output from the variable length/fixed length instruction transmitting unit 2124 to the variable length/fixed length instruction receiving unit 2214, the variable length/fixed length instruction receiving unit 2214 outputs variable length/fixed length information S04 to the variable length/fixed length determination unit 2263. Thus, the variable length/fixed length determination unit 2263 sets one of the two method described above, as a method for reading a file name list for the external memory read-out unit 2230.

The external memory read-out unit 2230 reads out, based on the setting, a file name list from the external memory 1001 and stores the file name list in the internal memory 2240. The external memory read-out unit 2230 reads a play list from the external memory 1001 and stores the play list in the internal memory 2240.

When the character string conversion mode information S23 is output from the character string conversion mode transmitting unit 2122 to the character string conversion mode receiving unit 2212, the character string conversion mode receiving unit 2212 outputs character string conversion mode information S07 to the character string conversion unit 2266. The character string conversion unit 2266 converts, based on the character string conversion mode information S07, a character code system of the play list stored in the internal memory 2240 into the same character code system as that of the file name list and re-stores the converted character code system in the internal memory 2240. Thus, the respective character code systems of the file name list and the play list become the same.

When the search range information S27 of the file name list is output from the search range information transmitting unit 2126 to the search range information receiving unit 2216, the search range information receiving unit 2216 outputs search range information S06 to the search range setting unit 2265. The search range setting unit 2265 sets a search range of the file name list stored in the internal memory 2240 and outputs a search range signal S14 to the matching comparison unit 2220.

The matching comparison unit 2220 performs comparison with each file name in the file name list stored in the internal memory 2240 to find a file name matching the comparison target character string in the search range of the file name list.

As a result of the comparison with file names in the search range, if no matching file name is found and the read operation has been completed for the number of times set by the read-out number determination unit 2262, a file number S16 (i.e., an error number) to indicate an error is output to the matching file number transmitting unit 1212.

Moreover, if no matching file name is found and the read operation has not yet completed for the number of times set by the read-out number determination unit 2262, the rest of file names included in the file name list are read from the external memory 1001 to the internal memory 2240 and comparison of the comparison target character string with each of the rest of the files is performed again by the matching comparison unit 2220.

Moreover, when a matching file name is found, the marching comparison unit 2220 outputs a file number corresponding to the matching file name as the file number S16 to the matching file number transmitting unit 1212, the matching file number transmitting unit 1212 outputs the file number S16 as file number S29 to the matching file number receiving unit 1122. The matching file number receiving unit 1122 outputs the file number S29 as file number S18 to the matching file judgment unit 2130.

When the file number S18 is not the file number of an audio file included in the directory to which a search is performed, the matching file judgment unit 2130 outputs re-search instruction signal S20 to the re-search instruction information transmitting unit 2125. The re-search instruction transmitting unit 2125 outputs the re-search instruction signal S20 as a re-search instruction signal S26 to the re-search instruction information receiving unit 2215. Then, the re-search instruction information receiving unit 2215 outputs the re-search instruction signal S26 as re-search instruction signal S05 to the re-search determination unit 2264. Thus, the re-search determination unit 2264 outputs a re-search instruction signal S13 to the matching comparison unit 2220 and the matching comparison unit 2220 performs comparison, without changing the comparison target character string, to a subsequent file name in the file name list to the file name to which the comparison has been performed.

Moreover, if the file number S18 is the file number of an audio file included in the directory to which a search is performed, the matching file judgment unit 2130 outputs the file number S18 as file number S19 to the reproduction order determination unit 2110. When the reproduction order determination unit 2110 receives the file number S19, file numbers are stored in the order in which the file numbers have been received.

When the comparison is completed for all of file names included in the play list, the reproduction order determination unit 2110 outputs a decode instruction S17 to the decode instruction transmitting unit 1123. The decode instruction transmitting unit 1123 outputs the decode instruction S17 as the decode instruction S30 to the decode instruction receiving unit 1213. The decode instruction receiving unit 1213 outputs the decode instruction S30 as a decode instruction S21 to the audio data decoding processing unit 1250. Moreover, the control circuit 2100 instructs the audio-file recording medium read-out unit to read audio files to be reproduced, so that the audio files are stored in the external memory 1001.

When the control circuit interface 2210 instructs the external memory read-out unit 2230 to read audio files, the external memory read-out unit 2230 reads the designated audio files from the external memory 1001 and stores the audio files in the internal memory 2240. When the audio data decoding unit 1250 receives the decode instruction S21, the audio data decoding unit 2250 reads each of the audio files stored in the internal memory 2240, performs decoding thereto and outputs PCM data.

According to this embodiment, time required for the comparison is less influenced by a state of a load in a control circuit, so that reproduction can be quickly started.

Furthermore, even if the size of a file name list is increased because a large number of audio files are stored in an external memory, a character string length of a file name is large and the like, a range in which comparison is performed is limited and thus even higher speed comparison can be performed.

In Embodiment 2, the case where the character code system of a play list is converted into the same character code system as that of a file name list by the character string conversion unit 2266 has been described as an example. However, the character code system of a file name list may be converted into the same character code system as that of the play list, or the respective character code systems of the file name list and the play list may be converted into a predetermined character code system.

Moreover, in each of Embodiment 1 and Embodiment 2, the case where a play list is stored in a recording medium such as a CD-ROM has been described. However, the audio reproducing apparatus may be so configured to read a play list stored in a different recording medium, such as a memory card, from a recording medium in which audio files are recorded.

Moreover, the CD described as a recording medium is just an example. As long as a recording medium is capable of recording an audio file, the recording medium is not limited to the above-described example.

As has been described, an audio reproducing apparatus according to the present invention exhibits the effect of being capable of quickly starting reproduction of an audio file according to a play list, and therefore is useful as an audio reproducing apparatus for reproducing an audio file and the like.

1. An audio reproducing apparatus for reading one or more audio files recorded on a recording medium according to a play list to indicate a reproduction order and reproducing an audio signal, the apparatus comprising:
a signal-processing processor for reproducing the audio signal; and
a control processor for controlling an operation of the audio reproducing apparatus,
wherein, based on one or more file names included in the play list, the signal-processing processor performs a search in a file list to indicate the one or more audio files recorded on the recording medium for read-out file information to be used for reading each of the one or more audio files from the recording medium, and
wherein the control processor controls reproduction of the audio signal in an order according to the play list using the read-out file information detected in the search.

2. The audio reproducing apparatus of claim 1, further comprising: an external memory for storing the file list and the play list,
wherein the file list includes a file name given to each of the one or more audio files recorded on the recording medium,
wherein the control processor outputs an address of the file list stored in the external memory to the signal-processing processor and instructs, using the read-out file information detected in the search, the signal-processing processor to perform reproduction of the audio signal in the order according to the play list, and
wherein the signal-processing processor includes an internal memory formed of a memory for temporarily storing the file list and the play list and for performing a data input/output operation at higher speed than an operation speed of the external memory and reproduces the audio signal by reading the file list from the address output by the control processor to the internal memory, comparing the file name described in the read out file list with a file name described in the play list, outputting read-out file information of an audio file having a matching file name and reading the audio file in the order instructed by the control processor in the internal memory.

3. The audio reproducing apparatus of claim 1, wherein the file list includes a file name given to each of the one or more audio files recorded on the recording medium,
wherein when a character code system of the file name included in the file list is different from a character code system of a file name included in the play list, the control processor instructs the signal-processing processor to convert at least one of the character code system of the file name included in the file list and the character code system of the file name included in the play list into a predetermined character code system so that the character code systems of the file name included in the file list and the file name included in the play list become the same, and
wherein the signal-processing processor performs the search according to an instruction by the control processor after the conversion for the character code systems has been performed.

4. The audio reproducing apparatus of claim 1,
wherein the control processor outputs information indicating the size of the file list to the signal-processing processor, and
wherein the signal-processing processor further includes an internal memory for temporarily storing the file list, reads the file list by performing read operations of a plurality of times, and performs the search at each time when a read operation is performed.

5. The audio reproducing apparatus of claim 4, wherein the signal-processing processor has a first reading function of reading a certain number of characters of a file name described in the file list to the internal memory, regardless of a length of the file name, and a second reading function of reading all characters of the file name into the internal memory, and
wherein the control processor instructs the signal-processing processor which of the first reading function or the second reading function is used to read the file name.

6. The audio reproducing apparatus of claim 1, wherein when performing the search to part of the file list, the control processor instructs the signal-processing processor in what range of the file list the signal-processing processor performs the search, and
wherein the signal-processing processor performs the search to the range of the file list.

7. The audio reproducing apparatus of claim 1, further comprising: an external memory to which the file list is read,
wherein the one or more audio files recorded on the recording medium is stored in a hierarchical structure,
wherein the file list further includes a directory name to identify a directory in a hierarchy,
wherein in the play list, a directory name is described so as to correspond to the file name,
wherein when the file list is read to the external memory, the control processor outputs a first address in which information for the file name included in the file list is stored and a second address in which information for the directory name included in the file list to the signal-processing processor, and
wherein the signal-processing processor performs a search for the file reading information, based on the file name included in the play list, from the information for the file name read out from the first address, and a search for information to specify a directory for reading each of the audio files from the recording medium from the information for the directory name read out from the second address.

8. The audio reproducing apparatus of claim 7, wherein the recording medium allows storage of audio files having a same file name,
wherein when an audio file corresponding to the read-out file information detected in the search by the signal-processing processor is not included in the directory to which the search is performed, the control processor instructs a re-search in the file list, and
wherein when the re-search is instructed, the signal-processing processor performs a search to part of the file list which has not been subjected to a search.
